(19) United States
(12) Patent Application Publication
(10) Pub. No.: US 2016/0171605 A9
(43) Pub. Date: Jun. 16, 2016

(54) APPARATUS, SYSTEM, AND METHOD FOR OIL AND GAS PORTFOLIO MANAGEMENT

(71) Applicant: Transzap, Inc., Denver, CO (US)

(72) Inventor: Jimmy L. Allison, Wheat Ridge, CO (US)

(73) Assignee: Transzap, Inc., Denver, CO (US)

(21) Appl. No.: 14/175,823

(22) Filed: Feb. 7, 2014

Related U.S. Application Data
(60) Provisional application No. 61/762,073, filed on Feb. 7, 2013.

(51) Int. Cl. G06Q 40/06; G06Q 50/06

(52) U.S. Cl. CPC G06Q 40/06; G06Q 50/06

(57) ABSTRACT

Implementations described and claimed herein provide apparatuses, systems, and methods for collecting oil and gas interests and for managing an oil and gas portfolio. In one implementation, interest information corresponding to one or more properties for which an interest is retained by a lease is received. The interest information is automatically aggregated based on an identification of each of the one or more properties. The aggregated interest information is retrieved from one or more databases for a property set including at least one property selected from the one or more properties. Financial information is generated for the property set. The financial information includes a plurality of financial attribute values of at least one financial attribute of the property set over a time interval. The plurality of financial attribute values are determined based on the aggregated interest information for the property set.

### CROSS-REFERENCE TO RELATED APPLICATIONS

The present application claims priority under 35 U.S.C. §119 to U.S. Provisional Application No. 61/762,073, which was filed Feb. 7, 2013 and entitled “Apparatus, System, and Method for Oil and Gas Portfolio Management.” The aforementioned application is hereby incorporated by reference in its entirety into the present application.

### TECHNICAL FIELD

Aspects of the present disclosure relate to data management and transaction services, among other functions, and more particularly to the management of oil and gas interests.

### BACKGROUND

Managing, tracking and accounting for royalty, working, and other interests or other similar forms of revenue in various industries, such as the oil and gas industry, can be cumbersome, disorganized, complicated and otherwise challenging. Generally, in the case of oil and gas royalty interests, an owner leases its various oil, gas, and/or mineral rights to a number of well operators and/or working interest owners (i.e., an owner that shares in the expense of operating the well and in the revenue obtained), often over a large and often dispersed geographic area. An operator captures revenue from the leased oil, gas, and/or minerals. The operator then pays a percentage of that revenue to the owner pursuant to the lease terms and shares any remaining revenue with the working interest owner. Stated differently, royalties represent the interests retained by an owner under an oil, gas, and/or mineral lease, and revenue from these interests is based upon a value of a percentage of the oil, gas, and/or minerals produced from the lease.

Often, managing royalty and working interests involves frequent revenue data exchange between an owner (e.g., royalty interest owner, working interest owner, overriding owner, or other interest owner) and its many individual lessors or well operators. As such, an owner has to keep track of revenue, property, and lease information pertaining to each of its interests, which can amount to a tremendous amount of data that: is frequently changing; originates from different sources; and is provided on different schedules and at different times. Thus, it is challenging for owners to manage their ownership interest, leases, and the revenue payments received from operators, among other challenges.

It is with these observations in mind, among others, that various aspects of the present disclosure were conceived and developed.

### SUMMARY

Implementations described and claimed herein address the foregoing problems, among others, by providing apparatuses, systems, and methods for collecting and managing oil and gas interests and for managing an oil and gas portfolio. In one implementation, interest information corresponding to one or more properties for which an interest is retained by a lease is received. The interest information is automatically aggregated based on an identification of each of the one or more properties. The aggregated interest information is retrieved from one or more databases for a property set including at least one property selected from the one or more properties. Financial information is generated for the property set. The financial information includes a plurality of financial attribute values of at least one financial attribute of the property set over a time interval. The plurality of financial attribute values are determined based on the aggregated interest information for the property set.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 is an example management system, including a portfolio management application running on a computer server or other similar device coupled with a network, for collecting and managing oil and gas interests;

FIG. 2 shows an example user interface generated by the portfolio management application, the user interface being displayed in a browser window of a computing device and displaying property information for which an owner has oil and gas interests;

FIG. 3 displays a window on the user interface for adding a new property;

FIG. 4 illustrates the user interface showing an oil and gas interest portfolio;

FIG. 5 shows the oil and gas interest portfolio as a bar chart;

FIG. 6 displays the oil and gas interest portfolio as a line chart;

FIG. 7 shows the oil and gas interest portfolio as a pie chart;

FIG. 8 illustrates oil and gas information displayed as a property set;

FIG. 9 illustrates example operations for collecting and managing oil and gas interests; and

FIG. 10 is an example of a computing system that may implement various systems and methods discussed herein.

### DETAILED DESCRIPTION

Aspects of the present disclosure involve apparatuses, systems, and methods for managing and collecting oil and gas interests (e.g., royalty interests, working interests, overriding interests, or other interests). In one particular aspect, a portfolio management application operates as a central point for an owner to manage an interest portfolio, including royalty and/or working interests the owner may have in oil, gas, and/or minerals. The portfolio management application manages and collects interest payment information for a plurality of properties. The properties and payment information may be entered manually or imported and compiled automatically from owner and/or operator data. As such, the portfolio management application manages an owner's interest portfolio, including mineral ownership, leases, and well property information along with interest payment detail.

In another aspect, the portfolio management application tracks, compiles, and presents interest information in the form of statements, reports, graphs, and associated documents (e.g., deeds, leases, wills, etc.). The interest information may be aggregated in various manners or displayed for each interest. For example, the interest information may be aggregated and presented according to an attribute, such as net value. Further, the portfolio management application may generate graphs or charts showing revenue growth over time, a net monthly financial contribution per property, and/or the like.

In still another aspect, the portfolio management application provides insight into interest activity and trends. The portfolio management application tracks and records costs and provides an analysis of payments and production. The portfolio management application uses the interest activity and trends to generate projections and alerts. The projections may be extrapolated based on past performance trends and other oil, gas, and mineral data. The activity, trends, and projections may also be used to obtain an offer to sell interests or a market evaluation of interests.

The various apparatuses, systems, and methods disclosed herein provide for collection and management of royalty, working, or other interests or revenues. The example implementation discussed herein references oil and gas mineral interests. However, it will be appreciated by those skilled in the art that the presently disclosed technology is applicable to other types of interest or revenue data.

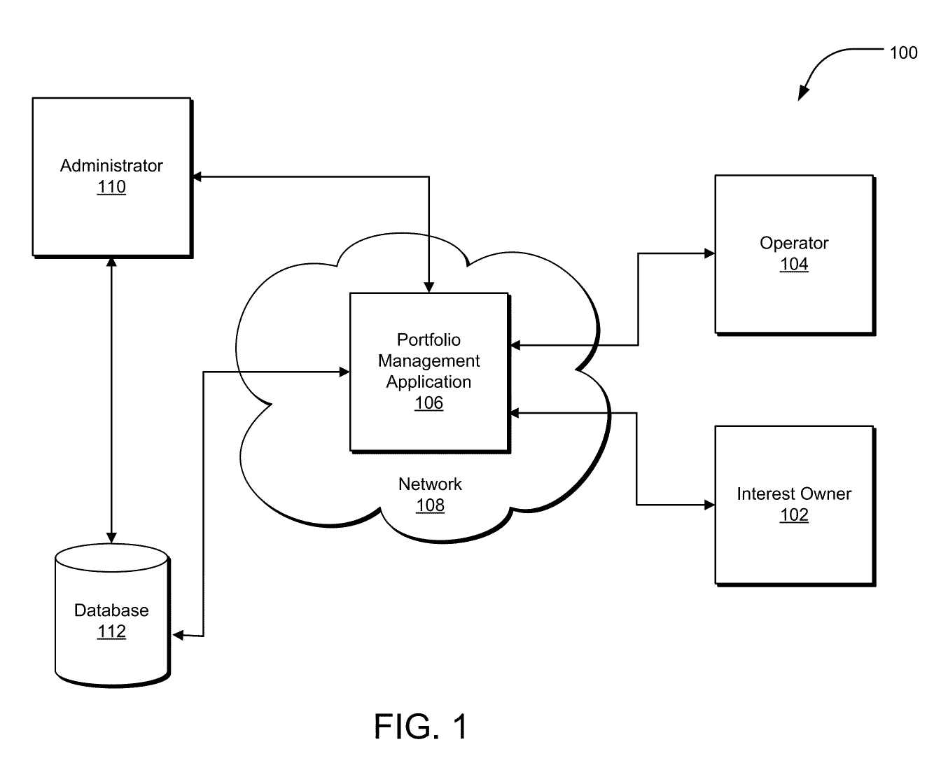

Referring to FIG. 1, an example management system 100 for collecting and managing oil and gas interests is shown. In one implementation, an interest owner 102 (e.g., royalty interest owner, working interest owner, overriding owner, or other interest owner) manages a portfolio of oil and gas interests associated with one or more wells each operated by an operator 104. The interest owner 102 manages the portfolio using a portfolio management application 106 via a network 108 (e.g., the Internet). An administrator 110 provides various management, transaction, registration, and support services, among other functions, for the interest owners 102 and the operators 104.

The network 108 is used by one or more computing or data storage devices (e.g., one or more databases 112) for implementing the portfolio management system 106. The interest owner 102, the operator 104, and/or the administrator 110 may access and interact with the portfolio management application 106 using a user device communicatively connected to the network 108. The user device is generally any form of computing device capable of interacting with the network 108, such as a personal computer, portable computer, terminal, work station, cellphone, mobile device, a tablet, a multimedia console, etc.

In one implementation, the network 108 includes a server hosting a website or an application that the interest owner 102 may visit to access the portfolio management application 106. The server may be a single server, a plurality of servers with each such server being a physical server or a virtual machine, or a collection of both physical servers and virtual machines. In another implementation, a cloud hosts one or more components of the management system 100. The user devices, the server, and other resources connected to the network 108 may access one or more other servers to access to one or more websites, applications, web services interfaces, storage devices, computing devices, etc. that are used to manage interests. The server may also host a search engine that the management system 100 uses for accessing and modifying interest information.

As can be understood from FIG. 1, interest information for the interest owner 102 received from the interest owner 102 and/or the operator 104 via the network 108 is stored in the database 112. In one implementation, the interest owner 102 has an account storing interest information for one or more properties, including revenue data exchanges between the operators 104 of those properties and the interest owner 102, in the database 112. Once the interest owner 102 logs in, the portfolio management application 106 automatically compiles and presents the oil and gas mineral interest information. Stated differently, the portfolio management application 106 parses the oil and gas mineral interest information stored in the database 112 to populate a property list showing wells for which the operators 104 are paying the interest owner 102 pursuant to a lease. In some implementations, the portfolio management application 106 may also send one or more communications to various data sources to obtain current interest data and update the database 112 before compiling and presenting the interest information. In another implementation, the interest owner 102, the operator 104, and/or the administrator 110 manually enters a property, interest payment details, and/or other interest information into the portfolio management application 106. Such manual entry may be used when, for example, the source of the interest data does not provide a data feed to the database 112.

As data is input or received into the portfolio management application 106, the network 108, and/or the database 112, the portfolio management application 106 updates the oil and gas mineral interest information in substantially real time for review and management by the interest owner 102. For example, the administrator 110 may establish a relationship with the operator 104 to obtain a data feed of payment details and other interest information, or the operator 104 may upload the information directly via the network 108. As such, the portfolio management application 106 operates as a mechanism for the interest owner 102 to review and manage the entire revenue data stream, including interest information, for each property in which the interest owner 102 has an oil and gas interest (e.g., royalty, working, etc.). In one implementation, the interest information is output in an electronic feed to which the interest owner 102 may subscribe. In another implementation, the interest information is displayed on a website, as described above.

In one implementation, the portfolio management application 106 lists each of the properties in which the interest owner 102 has an interest. The property list may be organized by property location, operator, or according to other commonalities. The property list may be displayed as a data tree, a table, a map, or the like. For each property of the interest owner 102, the portfolio management application 106 tracks, compiles, and displays: company information of the lessor of the oil, gas, and/or mineral interest; property information; and historical financial information.

The company information is provided for each lessor and/or operator of the oil, gas, and/or mineral interest, including, for example, the operator 104 and any associated working interest owners. In one implementation, the company information includes a company name, address, contact information, and website. However, other company information relevant to oil and gas mineral interest information is contemplated.

The property information involves data relating to the property, the operator 104, the lease terms, and interest. For example, the property information may include a variety of attributes, including, without limitation, a property identification number, an operator name, an operator identification number, a well name, a well identification number, an American Petroleum Institute (API) number, a lease identification number, a lease name, a lease date, a location of the well (county, state, etc.), an interest type (e.g., royalty, working, etc.), a mineral interest identification number, a mineral interest name, terms, a decimal interest, an acreage, a rental amount, a remitter identification number, a remitter name, and any comments. In one implementation, the interest owner 102 may edit the attributes using the portfolio management application 106. Further, in one implementation, locations of the properties are shown visually in a map with a link to the property information corresponding to each of the locations.

The historical financial information details a variety of financial attributes over a period of time (e.g., month intervals). The financial attributes may include, for example, a gross volume, a product type (e.g., oil, gas, other mineral, etc.), an interest type (e.g., royalty, working, override, etc.), a unit price, a gross value, gross taxes, gross deductions, and a net value.

The portfolio management application 106 manages an oil and gas portfolio of the interest owner 102 and compiles and presents financial performance trends. In one implementation, the financial performance trends are displayed for a timeframe (e.g., one month, six months, one year, etc.) and aggregated based on one or more of the financial attributes. Further, the financial performance trends may be aggregated and displayed for one or more properties or operators. For example, the financial performance trends may be displayed for properties of all of the operators 104 or of one of the operators 104. Alternatively or additionally, a property set may be created to display financial performance trends for selected properties. For example, the interest owner 102 may create a property set of its highest performing properties, its lowest performing properties, properties in a particular geographical region, or the like. The financial performance trends may be displayed, for example, in a table or in a graph or chart. The interest owner 102 may edit, delete, or add new property sets.

In one implementation, the portfolio management application 106 generates projections and alerts using the interest information and financial performance trends. The projections may be extrapolated based on past financial performance trends and other well information. Every well has a projected lifespan with generally the highest production points at the beginning of first production and as the hydrocarbon reserves come to the surface and sub-surface pressure is generally at its highest. Production declines over the lifespan of the well until production eventually ceases. Taking this information into account, the portfolio management application 106 generates a projected financial performance for one or more wells, operators, or the like over time. The interest owner 102, the operator 104, and/or another interested party may use the projected financial performance and financial performance trends, for example, for budgeting, borrowing, or other purposes.

In one implementation, the portfolio management application 106 generates alerts for new activities or performance anomalies or concerns. The portfolio management application 106 may compare current interest information for a property or operator 104 to past financial performance trends to determine if a well or operator 104 is suffering from a performance anomaly or other concern. For example, oil prices may be down or production may have fallen off. As a result, the portfolio management application 106 may compute a percentage drop in revenue or a reduction in net payments from the operator 104 and generate an alert notifying the interest owner 102 of the change. The portfolio management application 106 may further generate a list of recommendations for remedying the issue, such as contacting the operator 104, request an offer to sell the interest, or the like. In such an implementation, the list of recommendations may be obtained from the database 112 where recommendations are organized based on the type of change. Further, in one implementation, the portfolio management application 106 generates alerts for new activities, including, but not limited to, new interest information or revenue data received, payment received, payment past due or not received within historically expected timeframe, or other activities. The interest owner 102 and/or the administrator 110 may set preferences to generate alerts when the financial attributes are within or outside of a certain percentage, value, or tolerance, in some implementations.

The portfolio management application 106 may also permit the interest owner 102 to provide a third party limited access to interest information for one or more properties. For example, the interest owner 102 may provide access to a third party to obtain a market evaluation of one or more oil and gas interests, for example, for the purpose of offering to sell one or more oil and gas interests. In one implementation, the access is limited to evaluation information, including, for example, the location of the property, the age of the well, the production retrieved from the well over a given time interval (e.g., one year), the remaining reserves and end of life projection, and current prices for the product type (e.g., oil, gas, or other mineral). The location of the property may be particularly relevant if the well is located in a known basin or a geographically defined basin that is gas, oil, and/or mineral prolific. In another implementation, the third party has access limited to a defined time period, after which the third party will be unable to access any oil and gas interest information owned by the interest owner 102. The portfolio management application 106 may compile and send data to the third party, provide limited access via the network 108, and/or provide contact information and other relevant information to the third party and/or to the interest owner 102 so that the parties may contact each other directly.

Although the implementations described with respect to FIG. 1 generally reference management of a oil and gas interest portfolio by the interest owner 102, it will be appreciated that the operator 104 may utilize the portfolio management application 106 to track and compile information relating to the properties it is operating, lease information for each of the properties, interest payment deadlines, financial history and trends, or the like.

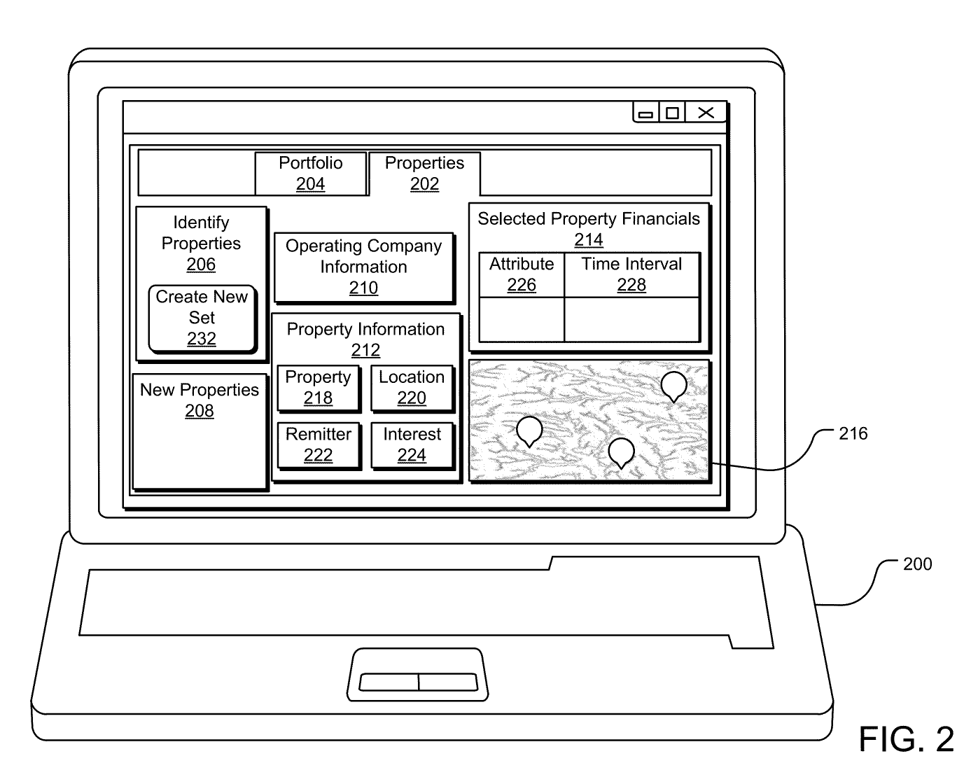

FIGS. 2-8 show an example user interface displayed on a computing device 200 through which access to and interactions with oil and gas interest information are controlled with the portfolio management application 106. It will be appreciated by those skilled in the art that such depictions are exemplary only and not intended to be limiting.

In one implementation, a user, such as the interest owner 102, the operator 104, the administrator 110, and/or another interested party, accesses the portfolio management application 106 via a link in an interest account designed to manage revenue data exchange etc. (e.g., Oildex Owner Relations Connect (ORC), or Oildex Checkstub Connect (CDEX)). In another implementation, the user connects directly to a homepage of the portfolio management application 106.

FIG. 2 shows an example user interface generated by the portfolio management application 106, the user interface being displayed in a browser window of the computing device 200. As can be understood from FIG. 2, the user interface includes a properties tab 202 and a portfolio tab 204. In one implementation, selection of the properties tab 202 displays data for the properties for which an owner has oil and gas interests. The data may include, without limitation, an identify properties panel 206, a new properties panel 208, operation company information 210, property information 212, selected property financials 214, and a map 216. However, additional information corresponding to the properties for which an owner has an interest is contemplated.

In one implementation, the identify properties panel 206 lists each of the operators and/or properties in which the user has an oil, gas, or other mineral interest (e.g., royalty interest, working interest, etc.). The identify properties panel 206 may display a tree node structure organizing the properties by operator, with each operator having one or more properties. Alternatively or additionally, the identify properties panel 206 may list the properties according to user created portfolios, property sets, common attributes, or preferences set by the user. In one implementation, the map 216 displays the geographic locations of each of the properties listed in the identify properties panel 206. The user may select a property from the map 216 using a link corresponding to the geographic locations shown in the map 216 or the identify properties panel 206.

The new properties panel 208 permits the user to add a new property and/or operator. In one implementation, the user may add a new property via the new properties panel 208 by manually entering data via an add new property link or by uploading data corresponding to an interest account of the user from the database 112 using, for example, select file or upload buttons.

In one implementation, the operation company information 210 and the property information 212 displays information after a property is selected in the identify properties panel 206. Once a property is selected, the operation company information 210 and the property information 212 presents interest information corresponding to the selected property. The user may edit the operation company information 210 and the property information 212.

The operating company information 210 includes company information of the lessor or operator of the oil, gas, and/or mineral interest in the selected property. For the selected property shown in FIG. 2, this information corresponds to an operating company. However, it will be understood that other companies, such one or more additional operators or working interest owners, may be included in the operating company information panel 210. In one implementation, the operating company information 210 includes a company name, address, contact information, and a company website.

The property information 212 includes a variety of attributes of the selected property and any comments. For example, the property information 212 may include property details 218, location details 220, remitter details 222, and interest details 224. In one implementation, the property details 218 specifies information regarding the property and may include, without limitation: a property identification number assigned by a user; an operator name; an API number assigned by the government to the well; a well name; a well identification number assigned by a user; a lease identification number; a lease name; a lease date; a mineral interest identification number; a mineral interest name; an acreage of the property; or other property details. The location details 220 may include any information regarding a geographical location of the well, such as a county, a state, a region, or the like. In one implementation, the remitter details 222 includes identification numbers and names assigned to the operator of the selected property. The interest details 224 includes information regarding the interest the owner has in the property including, but not limited to, an interest type (e.g., royalty interest, working interest, etc.), settlement amount, terms of the interest, a decimal interest, a rental amount, or other interest details.

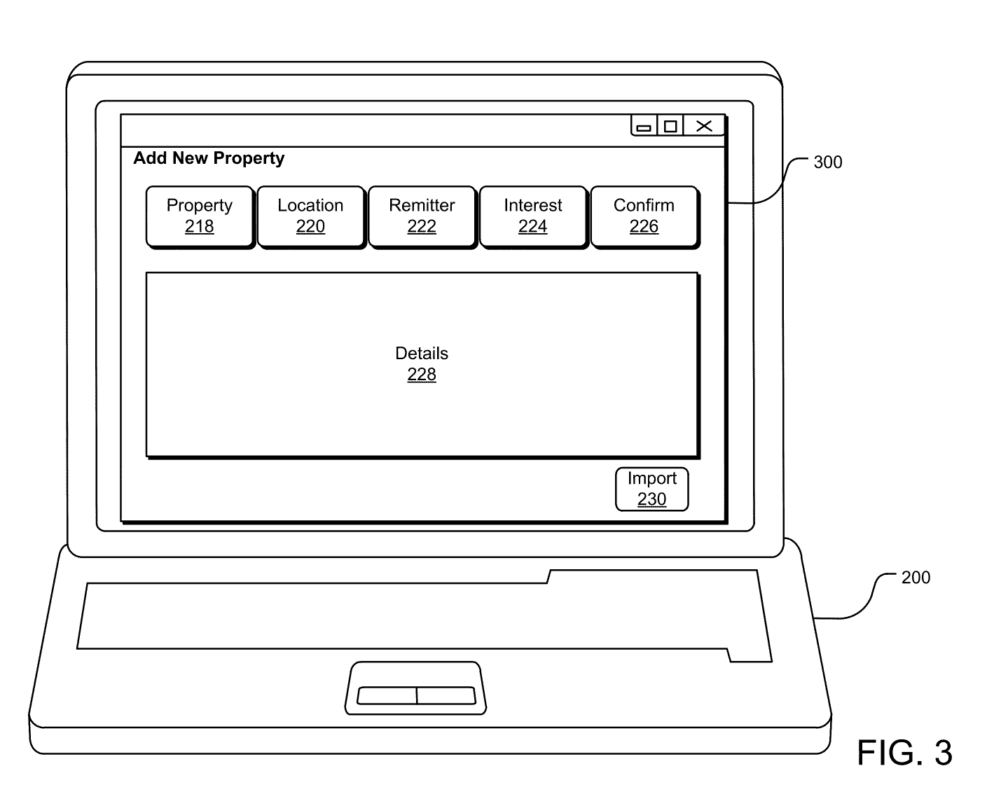

In one implementation, the property information 212 provides a link to add a new property similar to the new properties panel 208, which opens a pop-up box or window, as shown in FIG. 3, into which the user may enter attributes of the new property, including, for example, the name of the new property and the operator for that property. Once the user selects an add property button, the attributes are loaded and displayed in the property information 212, where the user may edit additional attributes and save the new property.

In one implementation, the selected property financials 214 includes historical financial information for the selected property. The historical financial information details a variety of financial attributes 226 over a time interval 228, such as on a monthly basis over a specified time period (e.g., 6 months, one year, or the like). The financial attributes 226 may include, without limitation, a gross volume, a product type (e.g., oil, gas, other mineral, etc.), a unit price, a gross value, gross taxes, gross deductions, and a net value.

Turning to FIG. 3, a window 300 for manually adding a new property is displayed. In one implementation, if the user chooses to manually enter a new property, for example, by selecting the add new property link in the property information 212 or by selecting an add new properties link in the new properties panel 208, the window 300 is presented. Using the window 300, the various attributes to display in the property information 212 and in the operating company information 210 of FIG. 2 may be entered. For example, the window 300 may include fields for entering details 228 for the property details 218, the location details 220, the remitter details 222, and the interest details 224. Additionally, in some implementations, the window 400 may include fields for entering payment details or other revenue data or history associated with the property. In one implementation, the window 300 additionally includes a button 230 for importing oil and gas interest information. Once the details 228 for each of the fields are entered or imported, the operating company information 210 and/or the property information 212 is presented for confirmation. The details may be confirmed using a confirm button 226.

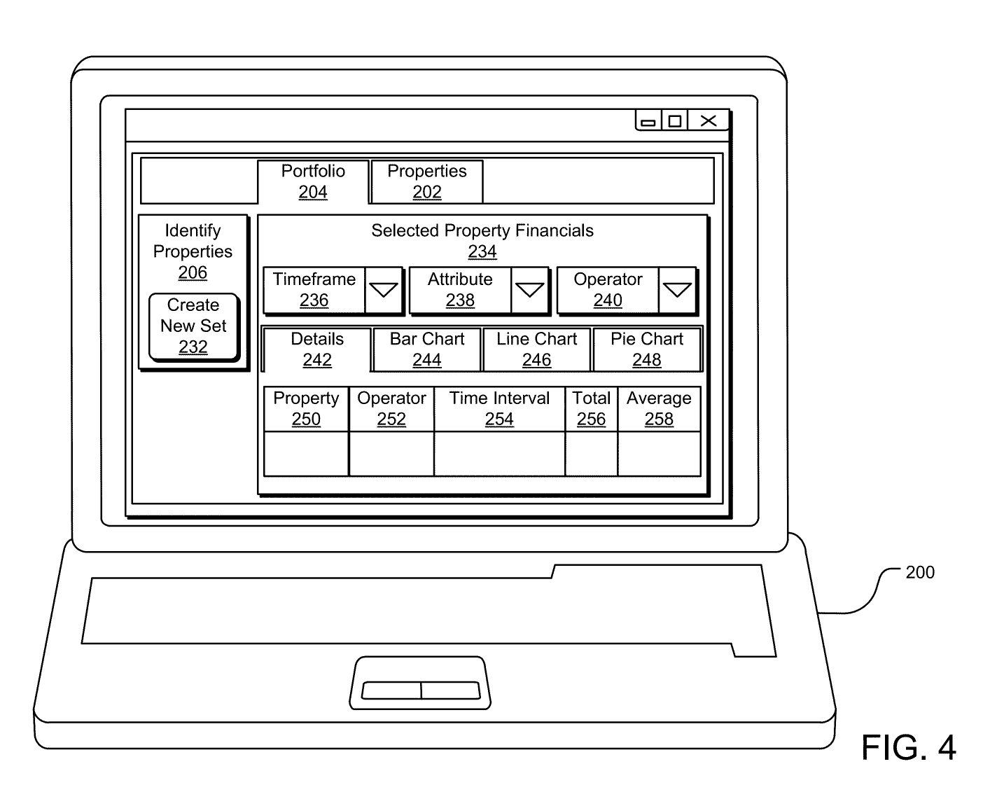

FIG. 4 shows an oil and gas interest portfolio 204 displayed on the user interface of the computing device 200. In the implementation shown in FIG. 4, the portfolio includes the identify properties panel 206 and selected property financials 234.

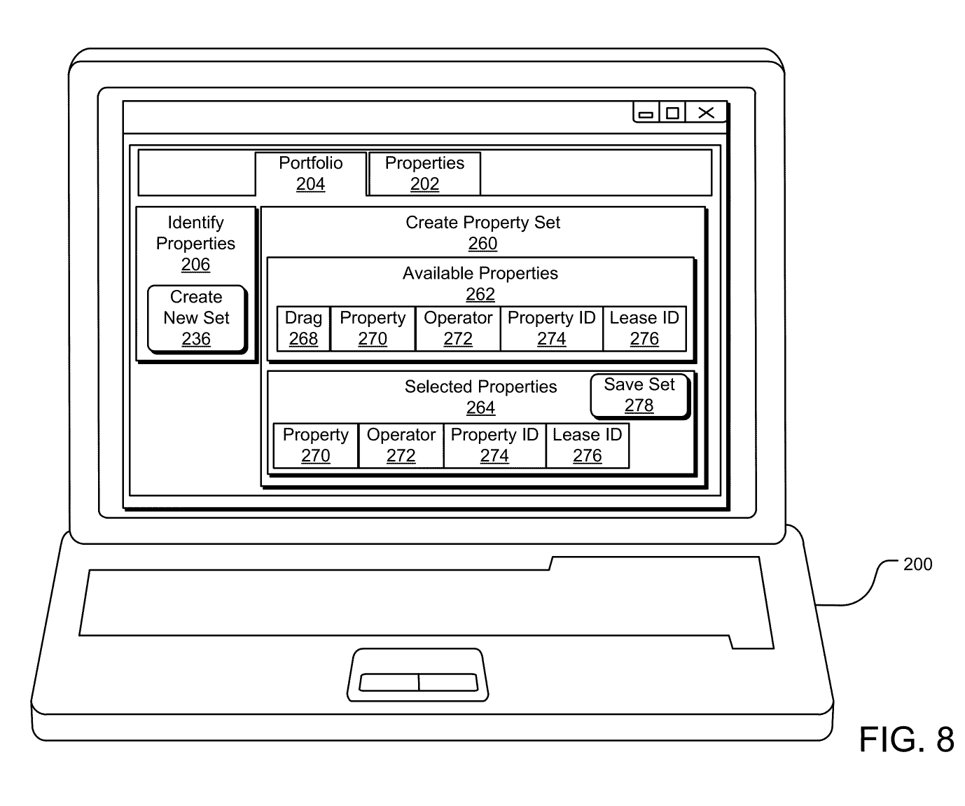

In the implementation shown in FIG. 4, the identify properties panel includes a create new set button or link 232 to create a portfolio set for which to display property financials. Once one or more properties are selected in the identify properties panel 206, selected property financials 234 is displayed including historical financial information. Alternatively, the user may select the create new set button or link 232 in the identify properties panel 306. A create new property set panel 260, as shown in FIG. 8, will then appear. The selected property financials 234 shows the performance of the selected properties over a given timeframe. The user may control the historical financial information displayed by adjusting the settings of a timeframe, one or more attributes or parameters, one or more product types, one or more operators, or the like, using for example, drop-down lists as shown in FIG. 4. In one implementation, the drop-down lists include a timeframe menu 236, an attribute menu 238, and an operator menu 240. However, other attributes or parameters relating to oil and gas interest information are contemplated.

The timeframe menu 236 allows the user to select the period of time over which the historical financial data is reported and displayed in the property financial panel.

The attribute menu 238 allows the user to select which attribute of the historical financial information to display over the selected timeframe. The available attributes may include, for example, gross volume, unit price, gross value, gross taxes, gross deductions, and net value. In one implementation, the available attributes include a product type (e.g., oil, gas, or minerals). In another implementation, the product type is a separate drop-down menu.

The operator menu 240 allows the user to select which operators to display in the historical financial information. For example, if a property set is selected that includes properties in a region that are operated by various operators, the user may choose to display information relating to all, one, or some of those operators for the selected property set. Similarly, if the user selects all properties in the identify properties panel 206, the user may filter the historical information according to which of the operators are selected. As such, in some implementations, the list of operators available in the operator menu depends on the selected properties.

The product type menu allows the user to select the type of product that is being produced at the selected property. Because prices for oil, natural gas, and other minerals vary significantly, by selecting the type of product, the user may obtain more accurate historical financial information.

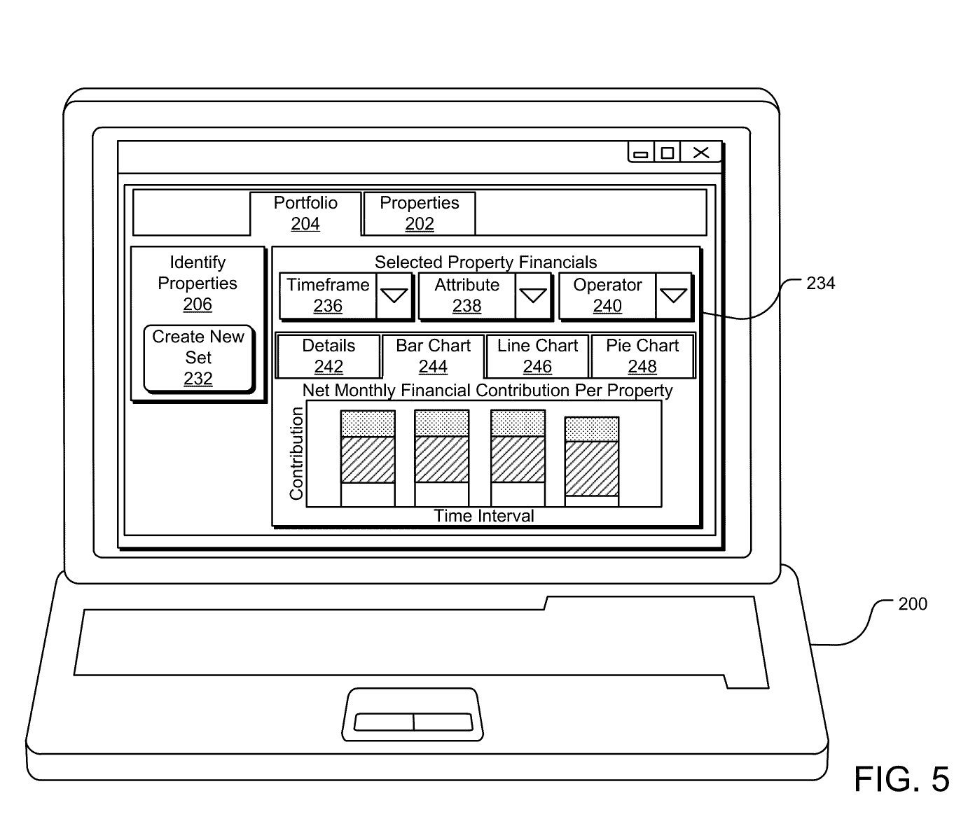

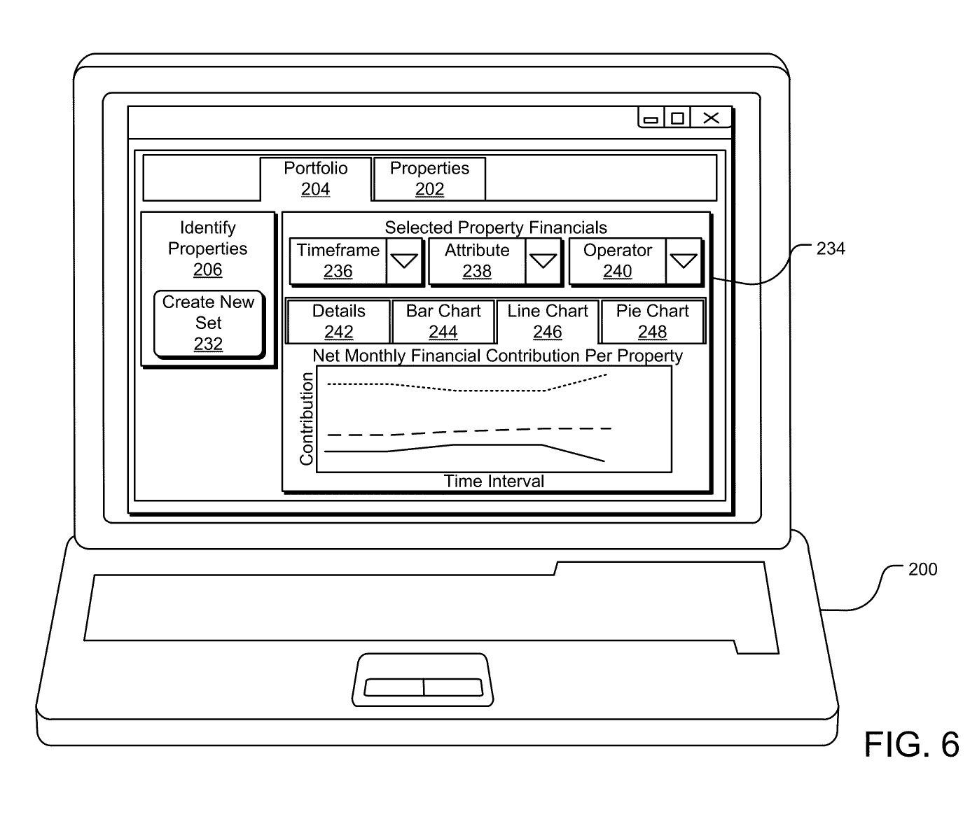

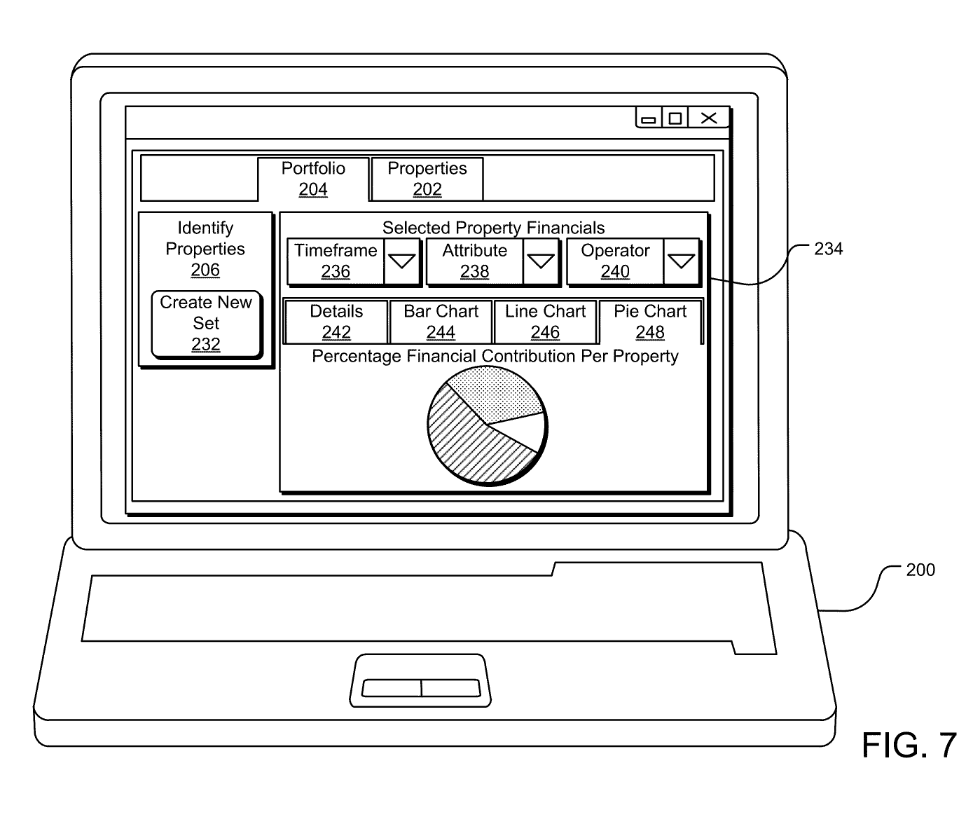

The historical financial information may be displayed in a table format, in a graph or chart, or other format. For example, FIG. 4 displays the details 242 of the historical financial information in a table, FIG. 5 shows the information as a bar chart 244, FIG. 6 shows the information as a line chart 246, and FIG. 7 shows the information as a pie chart 248. In one implementation, the details include the selected properties 250 and corresponding operators 252 along with the selected attributes over a time interval 254 selected using the timeframe 236. For example, the timeframe interval 254 may display the historical financial data for the selected attributes over a six month period on a monthly basis. A total 256 and an average 258 for the selected attribute may be shown for the selected property 250 and corresponding operator 252 in addition to the attribute data over the time interval 254. The historical financial information presents, among other information, the net financial contribution per property over the selected timeframe 236.

Referring to FIG. 8, the create property set panel 260 is shown. In the implementation shown in FIG. 8, the create property set panel 260 includes available properties 262 and selected properties 264.

Using the create property set panel 260, the user may name the set and select which properties to include. In one implementation, user may select properties from the available properties 262, which will then appear in the selected properties 264. For example, the user may drag and drop properties from the available properties 262 to the selected properties 264 using a drag feature 268.

To assist the user in creating the property set, property details 270, operator details, a property identification, and a lease identification 276 are presented. Once the user is satisfied with the selected properties 264, a save set button 278 may be selected, which adds the property set to the identify properties panel 206.

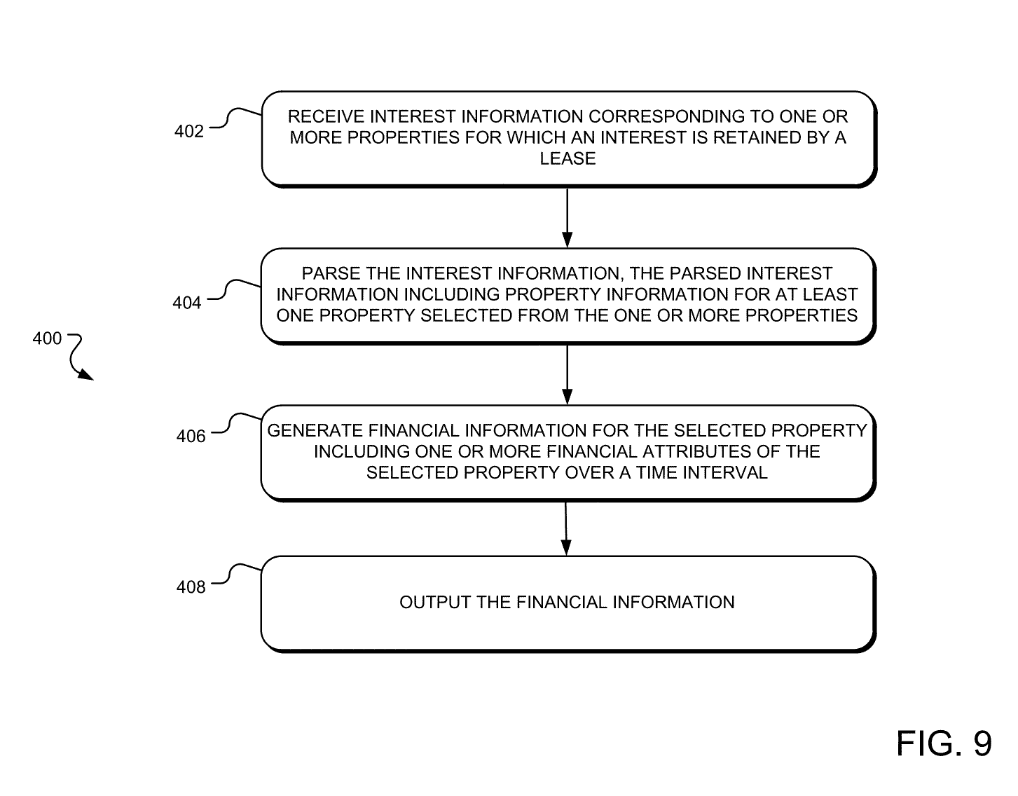

FIG. 9 illustrates example operations 400 for managing an interest portfolio, such as an oil, gas, or mineral interest portfolio. In one implementation, a receiving operation 402 receives interest information corresponding to one or more properties for which an interest is retained by a lease. The interest may be a royalty interest, a working interest, an overriding interest, or other interest. The interest information may be received from a variety of sources, as described herein, including, but not limited to, one or more data feeds, manual input, a user account, revenue data exchanges, or other data sources or third parties.

A parsing operation 404 parses the interest information, for example, based on a selection of one or more of the properties. The parsing operation 404 extracts information, including property information, for at least one property selected from the one or more properties. A generating operation 406 generates financial information for the selected properties. The financial information may be historical financial information, financial performance trends, or other financial information. The financial information includes one or more financial attributes of the selected properties over a time interval. In one implementation, the financial attributes include, without limitation, a gross volume, a product type (e.g., oil, gas, other mineral, etc.), an interest type (e.g., royalty, working, override, etc.), a unit price, a gross value, gross taxes, gross deductions, and a net value. The time interval may be a regular basis (e.g., monthly) over a selected period (e.g., six months).

An outputting operation 408 outputs the financial information, for example, into an electronic feed to which a user may subscribe or for display on a user interface. The outputting operation 408 may display the financial information visually, for example, in a table, a pie chart, a line chart, a bar chart, or the like.

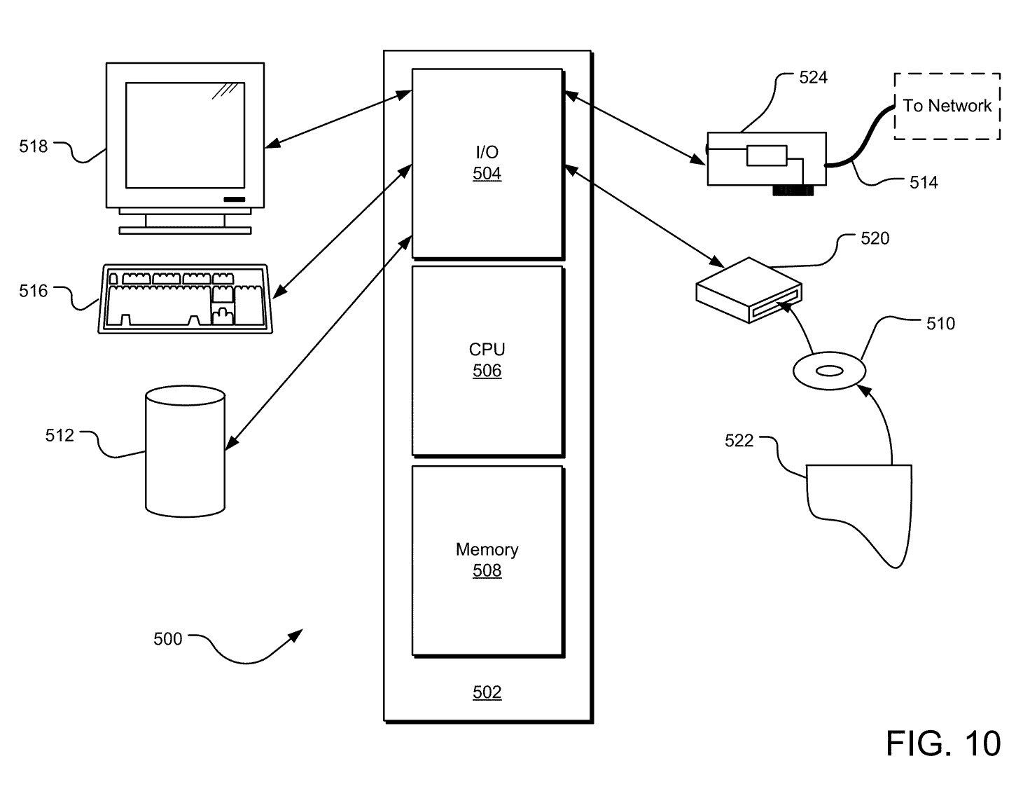

FIG. 10 is an example computing system 500 that may implement various systems and methods discussed herein. A general purpose computer system 500 is capable of executing a computer program product to execute a computer process. Data and program files may be input to the computer system 500, which reads the files and executes the programs therein. Some of the elements of a general purpose computer system 500 are shown in FIG. 10 wherein a processor 502 is shown having an input/output (I/O) section 504, a Central Processing Unit (CPU) 506, and a memory section 508. There may be one or more processors 502, such that the processor 502 of the computer system 500 comprises a single central-processing unit 506, or a plurality of processing units, commonly referred to as a parallel processing environment. The computer system 500 may be a conventional computer, a distributed computer, or any other type of computer, such as one or more external computers made available via a cloud computing architecture. The presently described technology is optionally implemented in software devices loaded in memory 508, stored on a configured DVD/CD-ROM 510 or storage unit 512, and/or communicated via a wired or wireless network link 514, thereby transforming the computer system 500 in FIG. 10 to a special purpose machine for implementing the described operations.

The I/O section 504 is connected to one or more user-interface devices (e.g., a keyboard 516 and a display unit 518), a disc storage unit 512, and a disc drive unit 520. Generally, the disc drive unit 520 is a DVD/CD-ROM drive unit capable of reading the DVD/CD-ROM medium 510, which typically contains programs and data 522. Computer program products containing mechanisms to effectuate the systems and methods in accordance with the presently described technology may reside in the memory section 504, on a disc storage unit 512, on the DVD/CD-ROM medium 510 of the computer system 500, or on external storage devices made available via a cloud computing architecture with such computer program products, including one or more database management products, web server products, application server products, and/or other additional software components. Alternatively, a disc drive unit 520 may be replaced or supplemented by a floppy drive unit, a tape drive unit, or other storage medium drive unit. The network adapter 524 is capable of connecting the computer system 500 to a network via the network link 514, through which the computer system can receive instructions and data. Examples of such systems include personal computers, Intel or PowerPC-based computing systems, AMD-based computing systems and other systems running a Windows-based, a UNIX-based, or other operating system. It should be understood that computing systems may also embody devices such as Personal Digital Assistants (PDAs), mobile phones, tablets or slates, multimedia consoles, gaming consoles, set top boxes, etc.

When used in a LAN-networking environment, the computer system 500 is connected (by wired connection or wirelessly) to a local network through the network interface or adapter 524, which is one type of communications device. When used in a WAN-networking environment, the computer system 500 typically includes a modem, a network adapter, or any other type of communications device for establishing communications over the wide area network. In a networked environment, program modules depicted relative to the computer system 500 or portions thereof, may be stored in a remote memory storage device. It is appreciated that the network connections shown are examples of communications devices for and other means of establishing a communications link between the computers may be used.

In an example implementation, royalty interest information, the portfolio management application 106, a plurality of internal and external databases (e.g., the database 112), source databases, and/or data cache on cloud servers are stored as the memory 508 or other storage systems, such as the disk storage unit 512 or the DVD/CD-ROM medium 510, and/or other external storage devices made available and accessible via a cloud computing architecture. Oil and gas interest management and revenue exchange software and other modules and services may be embodied by instructions stored on such storage systems and executed by the processor 502.

Some or all of the operations described herein may be performed by the processor 902. Further, local computing systems, remote data sources and/or services, and other associated logic represent firmware, hardware, and/or software configured to control operations of the management system 100. Such services may be implemented using a general purpose computer and specialized software (such as a server executing service software), a special purpose computing system and specialized software (such as a mobile device or network appliance executing service software), or other computing configurations. In addition, one or more functionalities of the management system 100 disclosed herein may be generated by the processor 502 and a user may interact with a Graphical User Interface (GUI) using one or more user-interface devices (e.g., the keyboard 516, the display unit 518, and the user devices 504) with some of the data in use directly coming from online sources and data stores. The system set forth in FIG. 10 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A computer system for managing an interest portfolio, the computer system comprising:
one or more databases configured to store interest information corresponding to one or more properties for which an interest is retained by a lease, the interest information obtained from a plurality of revenue exchanges over a network;
a portfolio management application executable by at least one processor and configured to generate financial information for a property set selected from the one or more properties, the financial information including a plurality of financial attribute values of at least one financial attribute of the property set over a time interval, the plurality of financial attribute values determined based on the interest information; and
a graphical user interface executable by the at least one processor, the graphical user interface configured to display the financial information for the property set.

2. The computer system of claim 1, wherein the property set includes one property selected from the one or more properties.

3. The computer system of claim 1, wherein the property set includes a plurality of properties selected from the one or more properties.

4. The computer system of claim 1, wherein the at least one financial attribute includes at least one of: a gross volume; a product type; an interest type; a unit price; a gross value; gross taxes; gross deductions; or a net value.

5. The computer system of claim 1, wherein the interest is at least one of: a royalty interest;
a working interest; or an override interest.

6. The computer system of claim 1, wherein the financial information for the property set is displayed as at least one of: a table; a line chart; a pie chart; or a bar chart.

7. The computer system of claim 1, wherein the financial information defines a net financial contribution for each property included in the property set over the time interval.

8. The computer system of claim 7, wherein the time interval is a future time interval and the net financial contribution is extrapolated based on past financial information.

9. The computer system of claim 7, wherein the time interval is a past time interval.

10. A method for managing an interest portfolio, the method comprising:
receiving interest information corresponding to one or more properties for which an interest is retained by a lease;
storing the interest information in one or more databases, the interest information automatically aggregated based on an identification of each of the one or more properties;
retrieving from the one or more databases the aggregated interest information for a property set including at least one property selected from the one or more properties;
generating financial information for the property set using a processor, the financial information including a plurality of financial attribute values of at least one financial attribute of the property set over a time interval, the plurality of financial attribute values determined based on the aggregated interest information for the property set; and
outputting the financial information.

11. The method of claim 10, wherein the interest information obtained from a plurality of revenue exchanges over a network between an owner of the interest and an operator of each of the one or more properties.

12. The method of claim 10, wherein the interest information is obtained from an electronic data feed received over a network.

13. The method of claim 10, wherein the interest is at least one of: a royalty interest; a working interest; or an override interest.

14. The method of claim 10, wherein the at least one financial attribute includes a gross volume; a product type; an interest type; a unit price; a gross value; gross taxes; gross deductions; and a net value.

15. The method of claim 10, wherein the financial information defines a net financial contribution for each property included in the property set over the time interval.

16. The method of claim 10, wherein outputting the financial information includes at least one of storing the financial information in a tangible storage medium or generating an electronic data feed of the financial information.

17. The method of claim 10, wherein outputting the financial information includes providing the financial information for display on a graphical user interface.

18. The method of claim 17, further comprising displaying the financial information in at least one of: a table; a line chart; a pie chart; or a bar chart.

19. One or more non-transitory tangible computer-readable storage media storing computer-executable instructions for performing a computer process on a computing system, the computer process comprising:
receiving interest information corresponding to a first property for which an interest is retained by a lease, the interest information obtained from a plurality of revenue exchanges over a network between an owner of the interest and an operator of the first property;
receiving interest information corresponding to a second property for which an interest is retained by a lease, the interest information extracted from a plurality of revenue exchanges over a network between the owner and an operator of the second property;
aggregating the interest information for the first property and the second property, the first property and the second property comprising a property set;
generating financial information for the property set including a plurality of financial attribute values of at least one financial attribute of the property set over a time interval, the plurality of financial attribute values determined based on the aggregated interest information for the property set; and
outputting the financial information.

20. The one or more tangible computer-readable storage media of claim 19, wherein the financial information defines a net financial contribution for the first property and the second property over the time interval.
